(19) United States
(12) Patent Application Publication
(10) Pub. No.: US 2026/0338984 A1
(43) Pub. Date: Oct. 29, 2026

(54) INTEGRATED AIR-GROUND COOPERATIVE EXCITATION TIME-FREQUENCY RECEIVING AIRBORNE ELECTROMAGNETIC DETECTION SYSTEM AND METHOD

(71) Applicant: Jilin University, Changchun (CN)

(72) Inventors: Yanzhang WANG, Changchun (CN); Yue ZHANG, Changchun (CN); Shilong WANG, Changchun (CN); Quan XU, Changchun (CN); Haigen ZHOU, Changchun (CN); Jun LIN, Changchun (CN); Haoran LI, Changchun (CN); Fengyue SUN, Changchun (CN); Zhaowen LIU, Changchun (CN); Gang LI, Changchun (CN); Chao WANG, Changchun (CN)

(73) Assignee: Jilin University, Changchun (CN)

(21) Appl. No.: 19/401,794

(22) Filed: Nov. 26, 2025

(30) Foreign Application Priority Data
Apr. 25, 2025 (CN) 202510525685.X

(51) Int. Cl. G01V 3/16; G01V 3/10; G01V 3/38

(52) U.S. Cl. CPC G01V 3/16; G01V 3/10; G01V 3/38

(57) ABSTRACT

An integrated air-ground cooperative excitation time-frequency receiving airborne electromagnetic detection system includes a time-frequency receiver, a helicopter airborne time-domain transmitter, a time-frequency receiver coil, and a ground frequency-domain transmitter. The electromagnetic detection method employs synchronized excitation of a time-domain pulsed signal transmitted from the helicopter in air and a frequency-domain continuous wave signal transmitted from the ground, with full airborne reception. Based on frequency point disposition and data decoupling technologies, the electromagnetic detection method enables acquisition of both helicopter airborne time-domain electromagnetic data and ground-air frequency-domain electromagnetic data in a single flight. The electromagnetic detection system of the present disclosure integrates the high-resolution imaging capability of the helicopter airborne time-domain electromagnetics for shallow geological structures at hundred-meter depth with the strong penetration characteristics of the ground-air frequency-domain electromagnetic system for deep geological structures.

### CROSS-REFERENCE TO RELATED APPLICATIONS

This application claims priority to Chinese Patent Application No. 202510525685.X, filed on Apr. 25, 2025, which is incorporated herein by reference in its entirety.

### TECHNICAL FIELD

The present disclosure relates to the technical field of airborne geophysical exploration, and specifically to an integrated air-ground cooperative excitation time-frequency receiving airborne electromagnetic detection system and method.

### BACKGROUND

Conventional fully-airborne helicopter-borne time-domain electromagnetic systems offer high resolution but are limited to investigation depths of only about hundred-meter scale. Semi-airborne frequency-domain or time-domain electromagnetic detection systems employing ground transmission and airborne reception achieve greater investigation depths but exhibit poorer overall resolution. Therefore, integrating fully-airborne helicopter-borne time-domain electromagnetic systems with semi-airborne frequency-domain or time-domain electromagnetic detection systems for electromagnetic surveys in the same survey area enables refined shallow stratum data acquisition while maintaining a large investigation depth range. However, if both electromagnetic detection systems operate simultaneously, the received electromagnetic signals mutually interfere, making the electromagnetic signals coupled and difficult to separate. Consequently, existing combined schemes for helicopter airborne electromagnetic methods and ground-air electromagnetic methods mostly employ time-division excitation, requiring separate flight surveys for each system's data, resulting in low efficiency and poor spatiotemporal data matching. The following documents pertain to some prior art.

Chinese Patent Publication CN115166833B discloses a hybrid field source electromagnetic detection system which is required to be equipped with two separate coils: an airborne high-sensitivity narrow-bandwidth coil and an airborne low-sensitivity wide-bandwidth coil. As it cannot achieve simultaneous reception of ground electrical source data and airborne magnetic source data in a single flight survey, its survey cost and efficiency are not optimized.

Chinese Application Publication CN107894620A discloses an airborne hybrid field source coded electromagnetic detection system where a helicopter platform carries both high-frequency transmission and reception antennas, and low-frequency transmission and reception antennas. It implements combined time-domain and frequency-domain transmission on the helicopter platform, with the time-domain transient electromagnetic detection system surveying deep geological bodies and the low-frequency pseudo-random transmission system responsible for surveying shallow geological bodies. However, due to limitations in the excitation source caused by the helicopter platform's power supply, the survey depth remains at the hundred-meter scale, which is dependent on the specific helicopter-borne time-domain electromagnetic system payload.

Chinese Patent Publication CN101303415B discloses a hybrid field source electromagnetic method combined field source transmission apparatus, which is designed to transmit switchable electrical source and magnetic source field signals within a single set of equipment. As it is designed for ground-based transmission sources and due to the power limitations of helicopters, it cannot be integrated into helicopter-borne electromagnetic detection systems.

Chinese Patent Publication CN101369025B discloses a combined field source artificial source frequency-domain electromagnetic sounding method which combines low/medium/high-frequency transmitters with low/medium/high-frequency receivers. The method simultaneously receives geoelectric response information for all frequencies across different frequency groups via a combined current excitation signal that comprises different primary frequencies and power levels in a single operation. However, as a frequency-domain ground electromagnetic detection method, it is unable to achieve rapid geological detection in complex terrain areas.

### SUMMARY

To solve the above problems, the present disclosure provides an integrated air-ground cooperative excitation time-frequency receiving airborne electromagnetic detection system and method. The system and method achieve simultaneous acquisition of helicopter time-domain electromagnetic data for high-resolution shallow investigation and ground-air frequency-domain electromagnetic data for large-depth investigation in a single flight, through full reception of both ground frequency-domain electromagnetic electrical source responses and airborne time-domain electromagnetic magnetic source responses, frequency point disposition, and electromagnetic response decoupling methods. Based on the highly mobile helicopter platform, the present disclosure combines the advantages of high shallow resolution from helicopter airborne time-domain electromagnetic detection and the large depth investigation capability from helicopter ground-air frequency-domain electromagnetic detection, realizing highly efficient, rapid, large-scale, comprehensive electromagnetic exploration adaptable to challenging geological conditions.

To achieve the above objective, the solutions provided by the present disclosure are as follows.

An integrated air-ground cooperative excitation time-frequency receiving airborne electromagnetic detection system, including a helicopter-mounted assembly and a ground assembly, wherein the helicopter-mounted assembly includes cabin equipment and suspended equipment suspended below a helicopter via a suspension cable, and the suspended equipment is electrically connected to the cabin equipment via a cable.

The suspended equipment includes:
a helicopter airborne time-domain electromagnetic transmitter coil;
a helicopter airborne time-domain electromagnetic bucking coil electrically connected to the helicopter airborne time-domain electromagnetic transmitter coil;
an attitude sensor mounted on the helicopter airborne time-domain electromagnetic transmitter coil;
a time-frequency receiver coil fixed on a horizontal cross cable; and
a preamplifier fixed on the suspension cable and electrically connected to the time-frequency receiver coil;

The cabin equipment includes:
a helicopter airborne time-domain transmitter electrically connected to the helicopter airborne time-domain electromagnetic transmitter coil, wherein the helicopter airborne time-domain transmitter is configured to generate a bipolar pulsed current in the helicopter airborne time-domain electromagnetic transmitter coil, and the bipolar pulsed current serves as a magnetic source;
a time-frequency receiver configured to acquire an induced voltage signal from the time-frequency receiver coil after amplification of the induced voltage signal by the preamplifier, and to acquire other auxiliary information;
a radar altimeter configured to acquire helicopter altitude above ground level (AGL) information and transmit the AGL information to the time-frequency receiver; and
a global positioning system (GPS) device configured to acquire GPS information of the helicopter and transmit the GPS information to the time-frequency receiver;

The ground assembly includes:
two grounding electrodes inserted into the ground;
a ground frequency-domain transmitter electrically connected to the grounding electrodes, wherein the ground frequency-domain transmitter is configured to generate a 2ⁿ pseudo-random continuous wave current between the two grounding electrodes; and the ground frequency-domain transmitter and the two grounding electrodes are located on a straight line; and
a ground station configured to acquire three-component magnetic field data of a natural field, wherein the ground station includes a three-component receiving sensor and a supporting acquisition device.

The helicopter airborne time-domain transmitter and the ground frequency-domain transmitter are excited simultaneously, and a minimum frequency difference between the following two frequency sets is greater than 0: the time-domain electromagnetic excitation fundamental frequency and the odd harmonics thereof of the helicopter airborne time-domain transmitter, and all 2ⁿ pseudo-random excitation frequency points of the ground frequency-domain transmitter.

As a specific embodiment of the present disclosure, in the ground station, the X-component and the Y-component of the three-component receiving sensor are parallel to the geomagnetic north-south direction and the east-west direction, respectively; and the Z-component is completely perpendicular to the geoid.

As a specific embodiment of the present disclosure, a relative height difference between the cabin equipment and the suspended equipment is 30 meters to 50 meters.

An integrated air-ground cooperative excitation time-frequency receiving airborne electromagnetic detection method includes the following steps.

S1: arranging the ground frequency-domain transmitter, the grounding electrodes, and the ground station according to a survey area location; setting a survey line; and determining a time-domain electromagnetic excitation fundamental frequency f₀ of the helicopter airborne time-domain transmitter and a 2ⁿ pseudo-random excitation fundamental frequency f₁ of the ground frequency-domain transmitter.

The rule for determining the time-domain electromagnetic excitation fundamental frequency f₀ and the 2ⁿ pseudo-random excitation fundamental frequency f₁ is as follows:
determining each excitation fundamental frequency with an optimization objective of maximizing a minimum frequency difference between the following two frequency sets: the time-domain electromagnetic excitation fundamental frequency and the odd harmonics thereof, and all 2ⁿ pseudo-random excitation frequency points; the objective function is as follows:

Max(|N₀f₀−N₁f₁|min)

N₀∈{1,3,5,7 . . . },N₁∈{2⁰,2¹,2²,2³, . . . ,2ⁿ⁻¹}
where N₀ represents the order of the time-domain electromagnetic excitation harmonics; n represents the order of the 2ⁿ pseudo-random sequence;

or determining each excitation fundamental frequency with an optimization objective of maximizing a minimum frequency difference between the following two frequency sets: odd and even harmonics of the time-domain electromagnetic excitation fundamental frequency, and all 2″ pseudo-random excitation frequency points; the objective function is as follows:

Max(|N₀f₀−N₁f₁|min)

N₀∈{1,2,3,4 . . . },N₁∈{2⁰,2¹,2²,2³, . . . ,2ⁿ⁻¹}

When solving the above objective functions, it is found that under both conditions, the two excitation fundamental frequencies and the maximized minimum frequency difference satisfy specific relationships. Therefore, the specific relationships can be used to determine the respective excitation fundamental frequencies, thereby reducing computational load. Thus, as a specific embodiment of the present disclosure:
when determining each excitation fundamental frequency with the optimization objective of maximizing the minimum frequency difference between the following two frequency sets: the time-domain electromagnetic excitation fundamental frequency and the odd harmonics thereof, and all 2ⁿ pseudo-random excitation frequency points, the two excitation fundamental frequencies satisfy the following relationship:

$${f}_{1} = \frac{{f}_{0}}{3 \times {2}^{m}} m ∈ \{ 0 , 1 , 2 , … \}$$

where m is any non-negative integer; and at this time, the obtained maximized minimum frequency difference is:

$$Δ f = \frac{{f}_{0}}{3} ;$$

when determining each excitation fundamental frequency with an optimization objective of maximizing the minimum frequency difference between the following two frequency sets: odd and even harmonics of the time-domain electromagnetic excitation fundamental frequency, and all 2ⁿ pseudo-random excitation frequency points, the two excitation fundamental frequencies satisfy the following relationship:

$${f}_{1} = \frac{{f}_{0}}{5 \times {2}^{m}} m ∈ \{ 0 , 1 , 2 , … \}$$

at this time, the obtained maximized minimum frequency difference is:

$$Δ f = \frac{{f}_{0}}{5} .$$

In this step, the waveform of the helicopter airborne time-domain transmitter may be selected as an appropriate bipolar triangular wave pulse or bipolar trapezoidal wave pulse according to relevant geological data information; during grounding electrode arrangement, the distance between the electrodes and the geographical location are determined according to the survey area extent to ensure that the farthest end of the survey area is within the effective range of the frequency-domain excitation field; the ground station shall be arranged near the survey area and away from artificial interference; the survey lines shall be designed horizontally with equal spacing within the survey area according to the detection resolution, and reciprocal survey lines shall be arranged in key areas.

S2: starting equipment, including activating the suspended equipment using a ground power supply.

This step includes starting the ground station and acquiring three-component magnetic field data of the natural field; starting the ground frequency-domain transmitter at the determined 2ⁿ pseudo-random excitation frequency f₁; using the ground power supply to activate the time-frequency receiver, the radar altimeter, and the GPS device (including its auxiliary system), and starting the helicopter airborne time-domain transmitter at the determined time-domain electromagnetic excitation fundamental frequency f₀ and waveform, and activating the attitude sensor located on the helicopter airborne time-domain electromagnetic transmitter coil; and connecting to the helicopter power supply and then disconnecting the ground power supply.

S3: flying the helicopter along the survey line while maintaining an AGL of the suspended equipment between 30 meters and 200 meters; during flight, simultaneously activating the helicopter airborne time-domain transmitter and the ground frequency-domain transmitter; acquiring electromagnetic data by the time-frequency receiver; acquiring helicopter AGL information by the radar altimeter; acquiring GPS information of the helicopter by the GPS device; and binding the AGL information and the GPS information with the electromagnetic data via timestamps.

In this step, the electromagnetic data acquired by the time-frequency receiver is the airborne-excited time-domain magnetic source electromagnetic response signal and the ground-excited frequency-domain electric source electromagnetic response signal, which are induced by the time-frequency receiver coil and pre-amplified by the low-noise preamplifier.

S4: acquiring data from the time-frequency receiver, the attitude sensor, and the ground station after completion of the flight; splitting the acquired data according to the survey line; and aligning the electromagnetic data with geographical locations.

S5: performing data processing: based on the time-domain electromagnetic excitation fundamental frequency and odd harmonic frequencies thereof and the 2ⁿ pseudo-random excitation frequency points, processing the electromagnetic data processed in step S4 via constant amplitude comb filtering or other filters, then performing channel extraction to obtain helicopter airborne time-domain electromagnetic channel-extracted data; and processing the electromagnetic data processed in step S4 via fast fourier transform (FFT) or orthogonal phase-locking to obtain ground-air frequency-domain frequency point data, thereby completing data decoupling.

S6: performing inversion imaging: according to a ground-air frequency-domain electromagnetic inversion imaging method, calculating an apparent resistivity from the ground-air frequency-domain frequency point data and the ground station signal to obtain apparent resistivity information ρ_{freq} of the exploration area; according to a helicopter airborne electromagnetic inversion imaging method, calculating a resistivity from the helicopter airborne time-domain electromagnetic channel-extracted data to obtain resistivity information ρₜᵢₘₑ of the exploration area.

The present disclosure is the first to propose an airborne electromagnetic detection system featuring “simultaneous excitation of a helicopter airborne time-domain pulsed signal and a ground-air frequency-domain continuous wave signal, with integrated airborne time-frequency reception by the helicopter” under coordinated air-ground excitation, and proposes a time-frequency signal decoupling method specifically adapted to this airborne electromagnetic detection system. The data aliasing problem arising from simultaneous integrated reception is resolved through separated disposition of frequency points for time-frequency excitation and frequency-based filtering of electromagnetic data. Overall, leveraging the high mobility of the helicopter platform, the present disclosure integrates the high-resolution imaging capability of the airborne time-domain electromagnetics for shallow geological structures at hundred-meter depth with the strong penetration characteristics of the ground-air frequency-domain electromagnetics for deep geological structures, thereby establishing an all-terrain coverage, high-efficiency electromagnetic exploration system. The system is particularly suitable for large-scale resource exploration under complex surface conditions such as mountainous and water-covered areas. Compared to electromagnetic time-frequency excitation methods employing other ground sources, the present disclosure achieves refined shallow investigation while maintaining large investigation depth. Compared to separate flight surveys for ground-air frequency-domain electromagnetics and airborne time-domain electromagnetics, the present disclosure offers lower survey costs and higher survey efficiency.

### BRIEF DESCRIPTION OF THE DRAWINGS

FIG. 1 is a schematic diagram of the integrated air-ground cooperative excitation time-frequency receiving airborne electromagnetic detection system of the present disclosure.

FIG. 2 is a schematic diagram of frequency point data for the 7th-order 2ⁿ pseudo-random frequency-domain electromagnetics at a fundamental frequency of 8.4 Hz after data decoupling in Embodiment 2.

FIG. 3 is a schematic diagram of channel-extracted data for time-domain electromagnetics at a fundamental frequency of 25 Hz after data decoupling in Embodiment 2.

FIG. 4 is a schematic diagram of frequency point data for the 7th-order 2ⁿ pseudo-random frequency-domain electromagnetics at a fundamental frequency of 7.5 Hz after data decoupling in Embodiment 3.

FIG. 5 is a schematic diagram of channel-extracted data for time-domain electromagnetics at a fundamental frequency of 75 Hz after data decoupling in Embodiment 3.

FIG. 6 is an integrated air-ground cooperative excitation time-frequency receiving airborne electromagnetic detection method in Embodiment 2.

### DETAILED DESCRIPTION OF THE EMBODIMENTS

The following describes the present disclosure in further detail with reference to embodiments and accompanying drawings. However, the embodiments of the present disclosure are not limited to these.

### Embodiment 1

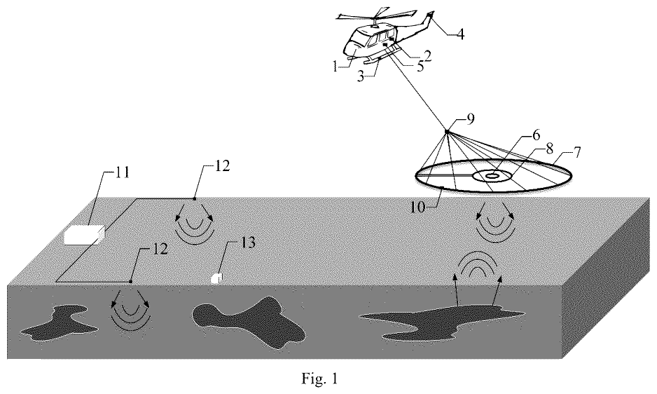

Please refer to FIG. 1, which shows a schematic diagram of a specific structure of the integrated air-ground cooperative excitation time-frequency receiving airborne electromagnetic detection system of the present disclosure. The integrated air-ground cooperative excitation time-frequency receiving airborne electromagnetic detection system of the present disclosure includes a helicopter-mounted assembly and a ground assembly. The ground assembly is arranged on the ground, and the helicopter-mounted assembly flies with the helicopter 1. The helicopter-mounted assembly further includes cabin equipment and suspended equipment. The suspended equipment and the helicopter 1 are structurally connected via a suspension cable and electrically connected via a cable. The relative height between the suspended equipment and the helicopter 1 is 30 meters to 50 meters.

The suspended equipment includes a helicopter airborne time-domain electromagnetic transmitter coil 7, a helicopter airborne time-domain electromagnetic bucking coil 8, an attitude sensor 10, a time-frequency receiver coil 6, and a preamplifier 9. The helicopter airborne time-domain electromagnetic bucking coil 8 is electrically connected to the helicopter airborne time-domain electromagnetic transmitter coil 7. The attitude sensor 10 is mounted on the helicopter airborne time-domain electromagnetic transmitter coil 7. The time-frequency receiver coil 6 is a flexible time-frequency receiver coil fixed on a horizontal cross cable. The preamplifier 9 is a low-noise preamplifier fixed on the suspension cable and electrically connected to the time-frequency receiver coil 6.

The cabin equipment includes a helicopter airborne time-domain transmitter 5, a time-frequency receiver 2, a radar altimeter 3, and a GPS device 4. The helicopter airborne time-domain transmitter 5 is electrically connected to the helicopter airborne time-domain electromagnetic transmitter coil 7 and is configured to generate a bipolar pulsed current in the helicopter airborne time-domain electromagnetic transmitter coil 7. The time-frequency receiver 2 is configured to acquire an induced voltage signal from the time-frequency receiver coil 6 after amplification of the induced voltage signal by the preamplifier 9, and to acquire other auxiliary information. The radar altimeter 3 is configured to acquire helicopter AGL information and transmit the AGL information to the time-frequency receiver 2. The GPS device 4 is configured to acquire GPS information of the helicopter 1 and transmit the GPS information to the time-frequency receiver 2.

The ground assembly includes a ground frequency-domain transmitter 11, two grounding electrodes 12, and a ground station 13. The two grounding electrodes 12 are connected to both ends of a cable and inserted into the soil. The cable is electrically connected to the ground frequency-domain transmitter 11. The two grounding electrodes 12 and the cable are located on a straight line. The ground frequency-domain transmitter 11 is configured to generate a 2ⁿ pseudo-random continuous wave current between the two grounding electrodes. The ground station 13 includes a three-component receiving sensor and a supporting acquisition device, and is configured to acquire three-component magnetic field data of a natural field. The X-component and the Y-component of the three-component receiving sensor are parallel to the geomagnetic north-south direction and the east-west direction, respectively; and the Z-component is completely perpendicular to the geoid. The airborne helicopter airborne time-domain transmitter 5 and the ground frequency-domain transmitter 11 are excited simultaneously. A minimum frequency difference between the following two frequency sets is greater than 0: the time-domain electromagnetic excitation fundamental frequency and the odd harmonics thereof of the helicopter airborne time-domain transmitter 5, and all 2ⁿ pseudo-random excitation frequency points of the ground frequency-domain transmitter 11.

### Embodiment 2

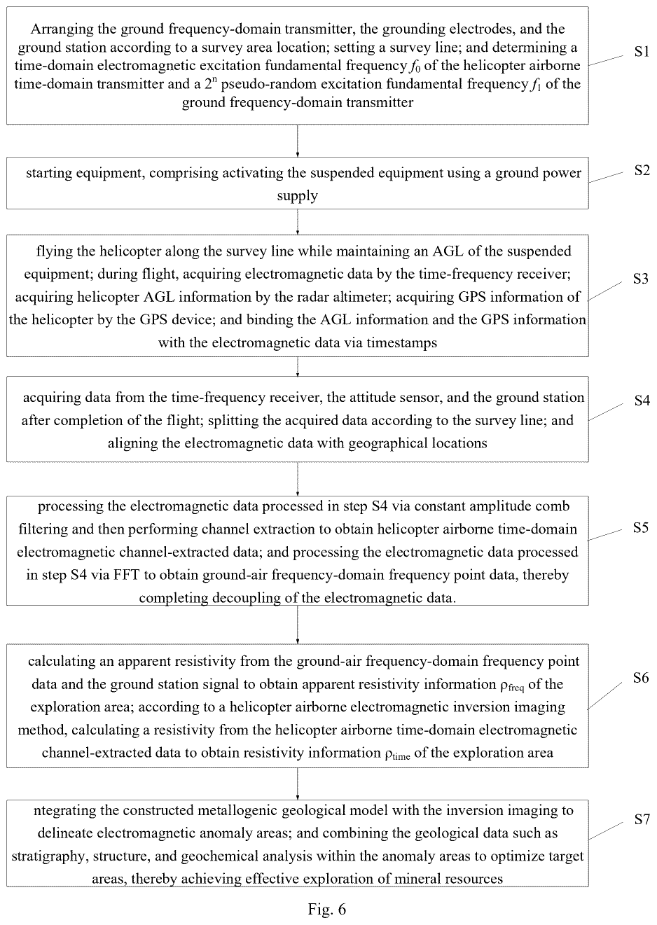

As shown in FIG. 6, an integrated air-ground cooperative excitation time-frequency receiving airborne electromagnetic detection method includes the following steps.

S1: arranging the ground frequency-domain transmitter, the grounding electrodes, and the ground station according to a survey area location; setting a survey line; and determining a time-domain electromagnetic excitation fundamental frequency f₀ of the helicopter airborne time-domain transmitter and a 2ⁿ pseudo-random excitation fundamental frequency f₁ of the ground frequency-domain transmitter.

Specifically, after selecting a time-domain electromagnetic excitation fundamental frequency of 25 Hz and determining that the excitation fundamental frequency of the 2ⁿ pseudo-random sequence is within the range of 5 Hz to 10 Hz with an order of 7, a base frequency of 8.4 Hz for the 2ⁿ pseudo-random sequence is selected with an optimization objective of maximizing the minimum frequency difference between the following two frequency sets: the time-domain electromagnetic excitation fundamental frequency and odd harmonics thereof, and all 2ⁿ pseudo-random excitation frequency points (with a step size of 0.1 Hz). A time-domain electromagnetic excitation triangular current waveform is set according to geological data information, with a peak excitation current of 500 A. Thirty mutually parallel horizontal survey lines are arranged at 100 m intervals. The two grounding electrode points are located at the edge of the exploration area, with a linear distance of 3 km between them; the ground frequency-domain transmitter is placed at the midpoint between the two grounding electrode points. The ground station is arranged 2 km northeast of the survey area, away from high-voltage power lines and factory buildings; the three-component receiving sensor is calibrated with the X/Y components aligned to the geomagnetic north-south/east-west directions, respectively, and the verticality error of the Z component is less than 0.5°.

S2: starting equipment, including starting the ground station and acquiring three-component magnetic field data of the natural field; starting the ground frequency-domain transmitter at the determined 2ⁿ pseudo-random excitation frequency f₁; using the ground power supply to activate the time-frequency receiver, the radar altimeter, and the GPS device (including its auxiliary system), and starting the time-domain transmitter at the determined time-domain electromagnetic excitation fundamental frequency f₀ and waveform; and activating the attitude sensor located on the helicopter airborne time-domain electromagnetic transmitter coil.

S3: flying the helicopter along the survey lines while maintaining an AGL of the suspended equipment between 30 meters and 150 meters; during the flight, simultaneously exciting the helicopter airborne time-domain transmitter and the ground frequency-domain transmitter; acquiring electromagnetic data (including the helicopter airborne time-domain electromagnetic response signal and the ground-air frequency-domain electromagnetic response signal) by the time-frequency receiver at a sampling rate of 192 kHz; acquiring helicopter AGL information by the radar altimeter; acquiring GPS information of the helicopter by the GPS device; and binding the AGL information and the GPS information with the electromagnetic data via timestamps.

S4: after completion of the flight, turning off the helicopter airborne time-domain transmitter and the ground frequency-domain transmitter; activating the ground power supply to retrieve data from the time-frequency receiver; retrieving data from the attitude sensor; saving the three-component magnetic field data from the ground station and then terminating the acquisition work of the ground station; segmenting the acquired data according to the survey lines, GPS data points, and planned survey line position coordinate points; and aligning the electromagnetic data with geographical locations via timestamps and GPS information.

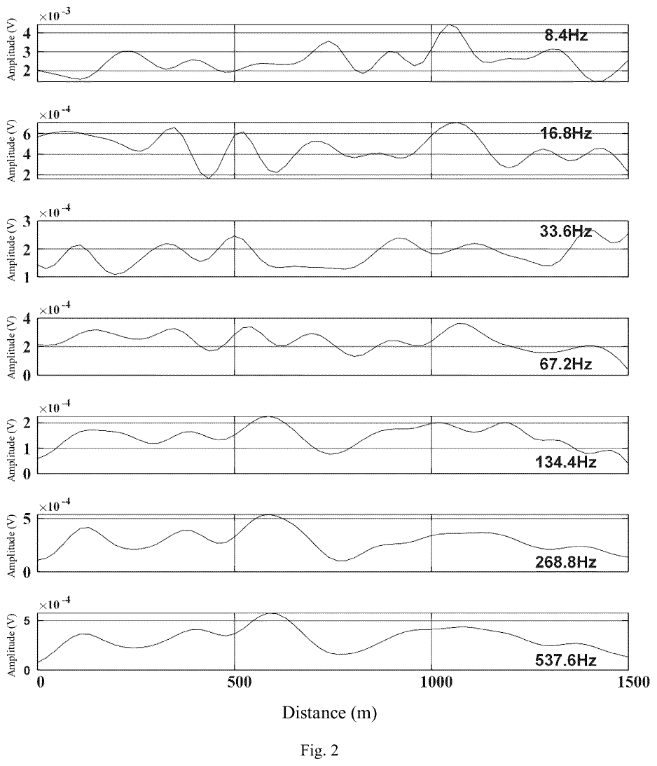

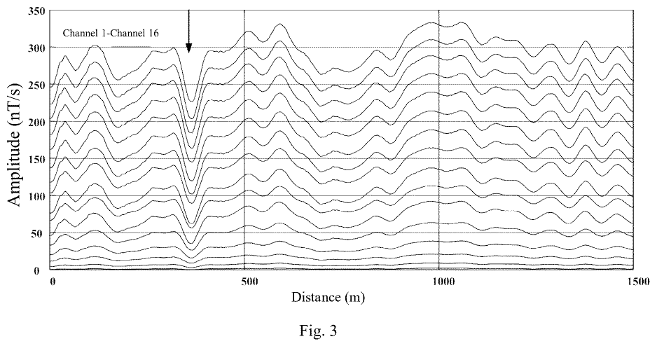

S5: performing data processing: based on the time-domain electromagnetic excitation fundamental frequency and odd harmonic frequencies thereof and the 2ⁿ pseudo-random excitation frequency points, processing the electromagnetic data processed in step S4 via constant amplitude comb filtering and then performing channel extraction to obtain helicopter airborne time-domain electromagnetic channel-extracted data; and processing the electromagnetic data processed in step S4 via FFT to obtain ground-air frequency-domain frequency point data, thereby completing decoupling of the electromagnetic data. The decoupled ground-air frequency-domain frequency point data is shown in FIG. 2, where the curves for each frequency point are smooth, the relationships between frequency points are clear, and the response amplitude magnitudes are close; the decoupled helicopter airborne time-domain electromagnetic channel-extracted data is shown in FIG. 3, where the curves for each time channel are smooth, the inter-channel relationships are distinct, and there is no overlap of inter-channel curves.

S6: performing inversion imaging: according to a ground-air frequency-domain electromagnetic inversion imaging method, calculating an apparent resistivity from the ground-air frequency-domain frequency point data and the ground station signal to obtain apparent resistivity information ρ_{freq} of the exploration area; according to a helicopter airborne electromagnetic inversion imaging method, calculating a resistivity from the helicopter airborne time-domain electromagnetic channel-extracted data to obtain resistivity information ρₜᵢₘₑ of the exploration area.

S7: performing data interpretation: integrating the constructed metallogenic geological model with the inversion imaging to delineate electromagnetic anomaly areas; and combining the geological data such as stratigraphy, structure, and geochemical analysis within the anomaly areas to optimize target areas, thereby achieving effective exploration of mineral resources.

### Embodiment 3

This embodiment follows the same steps as Embodiment 2, with the differences lying in different partial parameters. The specific differences are as follows.

In step S1, after selecting a time-domain electromagnetic excitation fundamental frequency of 75 Hz and determining that the excitation fundamental frequency of the 2ⁿ pseudo-random sequence is within the range of 5 Hz to 10 Hz with an order of 7, a base frequency of 7.5 Hz for the 2ⁿ pseudo-random sequence is selected with an optimization objective of maximizing the minimum frequency difference between the following two frequency sets: the odd and even harmonics of the time-domain electromagnetic excitation fundamental frequency, and all 2ⁿ pseudo-random excitation frequency points (with a step size of 0.5 Hz). A time-domain electromagnetic excitation trapezoidal current waveform is set according to geological data information, with a peak excitation current of 400 A. Fifty mutually parallel horizontal survey lines are arranged at 100 m intervals. The two electrode points are located at the edge of the exploration area, with a linear distance of 5 km between them; the ground frequency-domain transmitter is placed at the midpoint between the two electrode points. The ground station is arranged 1.5 km northeast of the survey area, away from high-voltage power lines and factory buildings; the three-component receiving sensor is calibrated with the X/Y components aligned to the geomagnetic north-south/east-west directions, respectively, and the verticality error of the Z component is less than 0.5°.

In step S3, the helicopter flies along the survey lines while maintaining the AGL of the suspended equipment between 30 meters and 100 meters.

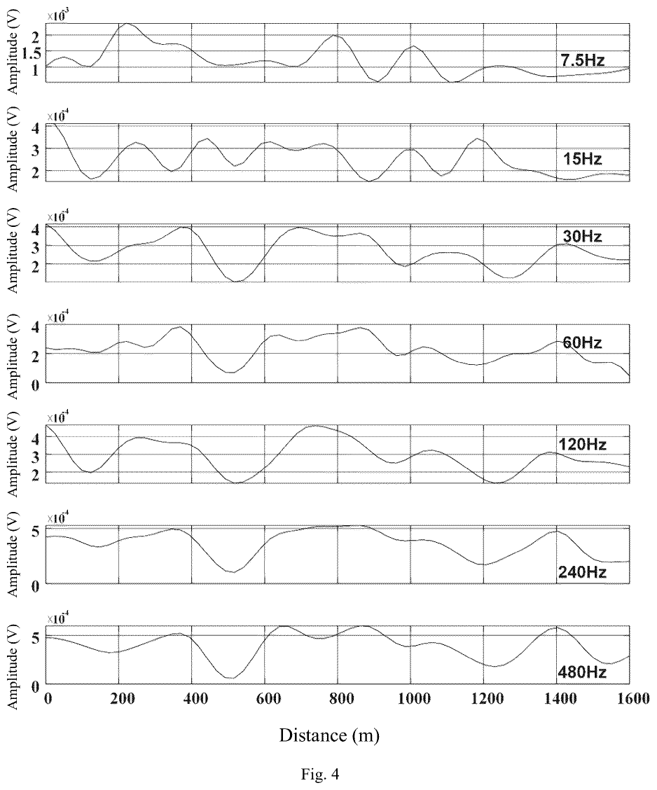

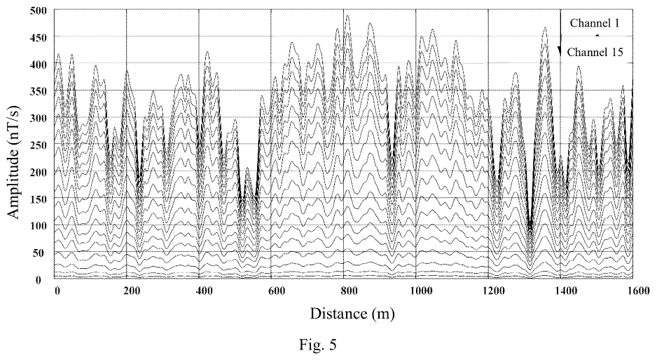

In step S5, the decoupled ground-air frequency-domain electromagnetic frequency point data is shown in FIG. 4, where the curves for each frequency point are smooth and the relationships between frequency points are clear; the decoupled helicopter airborne time-domain electromagnetic channel-extracted data is shown in FIG. 5, where the curves for each time channel are smooth and the inter-channel relationships are distinct.

The foregoing descriptions merely present preferred specific embodiments of the present disclosure. However, the protection scope of the present disclosure is not limited thereto. Any person skilled in the art may easily envision modifications or substitutions within the technical scope disclosed in the embodiments of the present disclosure, and all such modifications or substitutions shall fall within the protection scope of the present disclosure.

What is claimed is:

1. An integrated air-ground cooperative excitation time-frequency receiving airborne electromagnetic detection system, comprising a helicopter-mounted assembly and a ground assembly,
wherein the helicopter-mounted assembly comprises cabin equipment and suspended equipment suspended below a helicopter via a suspension cable, and the suspended equipment is electrically connected to the cabin equipment via a cable;
the suspended equipment comprises:
a helicopter airborne time-domain electromagnetic transmitter coil;
a helicopter airborne time-domain electromagnetic bucking coil electrically connected to the helicopter airborne time-domain electromagnetic transmitter coil;
an attitude sensor mounted on the helicopter airborne time-domain electromagnetic transmitter coil;
a time-frequency receiver coil fixed on a horizontal cross cable; and
a preamplifier fixed on the suspension cable and electrically connected to the time-frequency receiver coil;
wherein the cabin equipment comprises:
a helicopter airborne time-domain transmitter electrically connected to the helicopter airborne time-domain electromagnetic transmitter coil, wherein the helicopter airborne time-domain transmitter is configured to generate a bipolar pulsed current in the helicopter airborne time-domain electromagnetic transmitter coil;
a time-frequency receiver configured to acquire an induced voltage signal from the time-frequency receiver coil after amplification of the induced voltage signal by the preamplifier, and to acquire other auxiliary information;
a radar altimeter configured to acquire helicopter altitude above ground level (AGL) information and transmit the AGL information to the time-frequency receiver; and
a global positioning system (GPS) device configured to acquire GPS information of the helicopter and transmit the GPS information to the time-frequency receiver;
wherein the ground assembly comprises:
two grounding electrodes inserted into the ground;
a ground frequency-domain transmitter electrically connected to the grounding electrodes, wherein the ground frequency-domain transmitter is configured to generate a 2ⁿ pseudo-random continuous wave current between the two grounding electrodes; and the ground frequency-domain transmitter and the two grounding electrodes are located on a straight line; and
a ground station configured to acquire three-component magnetic field data of a natural field, wherein the ground station comprises a three-component receiving sensor and a supporting acquisition device; and
wherein the helicopter airborne time-domain transmitter and the ground frequency-domain transmitter are excited simultaneously, and a minimum frequency difference between the following two frequency sets is greater than 0: the time-domain electromagnetic excitation fundamental frequency and the odd harmonics thereof of the helicopter airborne time-domain transmitter, and all 2ⁿ pseudo-random excitation frequency points of the ground frequency-domain transmitter.

2. The integrated air-ground cooperative excitation time-frequency receiving airborne electromagnetic detection system according to claim 1, wherein a relative height difference between the cabin equipment and the suspended equipment is 30 meters to 50 meters.

3. The integrated air-ground cooperative excitation time-frequency receiving airborne electromagnetic detection system according to claim 1, wherein the X-component and the Y-component of the three-component receiving sensor are parallel to the geomagnetic north-south direction and the east-west direction, respectively; and
the Z-component is completely perpendicular to the geoid.

4. An integrated air-ground cooperative excitation time-frequency receiving airborne electromagnetic detection method, implemented using the integrated air-ground cooperative excitation time-frequency receiving airborne electromagnetic detection system according to claim 1, wherein the method comprises the following steps:
S1: arranging the ground frequency-domain transmitter, the grounding electrodes, and the ground station according to a survey area location; setting a survey line; and determining a time-domain electromagnetic excitation fundamental frequency f₀ of the helicopter airborne time-domain transmitter and a 2ⁿ pseudo-random excitation fundamental frequency f₁ of the ground frequency-domain transmitter;
wherein the rule for determining the time-domain electromagnetic excitation fundamental frequency f₀ and the 2ⁿ pseudo-random excitation fundamental frequency f₁ is as follows:
determining each excitation fundamental frequency with an optimization objective of maximizing a minimum frequency difference between the following two frequency sets: the time-domain electromagnetic excitation fundamental frequency and the odd harmonics thereof, and all 2″ pseudo-random excitation frequency points; or determining each excitation fundamental frequency with an optimization objective of maximizing a minimum frequency difference between the following two frequency sets: odd and even harmonics of the time-domain electromagnetic excitation fundamental frequency, and all 2″ pseudo-random excitation frequency points;
S2: starting equipment, comprising activating the suspended equipment using a ground power supply;
S3: flying the helicopter along the survey line while maintaining an AGL of the suspended equipment between 30 meters and 200 meters; during flight, simultaneously activating the helicopter airborne time-domain transmitter and the ground frequency-domain transmitter;
acquiring electromagnetic data by the time-frequency receiver; acquiring helicopter AGL information by the radar altimeter; acquiring GPS information of the helicopter by the GPS device;
and binding the AGL information and the GPS information with the electromagnetic data via timestamps;
S4: acquiring data from the time-frequency receiver, the attitude sensor, and the ground station after completion of the flight; splitting the acquired data according to the survey line; and
aligning the electromagnetic data with geographical locations;
S5: performing data processing: based on the time-domain electromagnetic excitation fundamental frequency and odd harmonic frequencies thereof and the 2ⁿ pseudo-random excitation frequency points, processing the electromagnetic data processed in step S4 via constant amplitude comb filtering or other filters, then performing channel extraction to obtain helicopter airborne time-domain electromagnetic channel-extracted data; and processing the electromagnetic data processed in step S4 via fast fourier transform (FFT) or orthogonal phase-locking to obtain ground-air frequency-domain frequency point data, thereby completing data decoupling; and
S6: performing inversion imaging: according to a ground-air frequency-domain electromagnetic inversion imaging method, calculating an apparent resistivity from the ground-air frequency-domain frequency point data and the ground station signal to obtain apparent resistivity information ρ_{freq} of the exploration area; according to a helicopter airborne electromagnetic inversion imaging method, calculating a resistivity from the helicopter airborne time-domain electromagnetic channel-extracted data to obtain resistivity information ρₜᵢₘₑ of the exploration area.

5. The integrated air-ground cooperative excitation time-frequency receiving airborne electromagnetic detection method according to claim 4, wherein the rule for determining the time-domain electromagnetic excitation fundamental frequency f₀ and the 2ⁿ pseudo-random excitation fundamental frequency f₁ is simplified as: the time-domain electromagnetic excitation fundamental frequency f₀ and the 2ⁿ pseudo-random excitation fundamental frequency f₁ satisfying the following relationship:
$${f}_{1} = \frac{{f}_{0}}{3 \times {2}^{m}} , or {f}_{1} = \frac{{f}_{0}}{5 \times {2}^{m}}$$
wherein m is any non-negative integer.
